(19) United States
(12) Patent Application Publication
(10) Pub. No.: US 2008/0078423 A1
(43) Pub. Date: Apr. 3, 2008

(54) SUBSTRATE PROCESSING METHOD AND SUBSTRATE PROCESSING APPARATUS

(76) Inventors: Hiroyuki Araki, Kyoto-shi (JP); Toyohide Hayashi, Kyoto-shi (JP)

Correspondence Address: OSTROLENK FABER GERB & SOFFEN, 1180 AVENUE OF THE AMERICAS, NEW YORK, NY, 100368403, US

(21) Appl. No.: 11/860,733

(22) Filed: Sep. 25, 2007

(30) Foreign Application Priority Data
Sep. 29, 2006 (JP) 2006-267008

(51) Int. Cl. B08B 3/04

(52) U.S. Cl. 134/22.19; 134/94.1

(57) ABSTRACT

Holes having a variety of shapes exist on a surface of a substrate. When pure water is supplied on the substrate in a rinsing process, part of the pure water enters the holes. The pure water which have entered the holes can be hardly shaken off even though the substrate is rotated at a high speed. Therefore, HFE is held on the substrate so as to form an HFE layer after the rinsing process. In this case, the HFE enters the holes while the pure water emerges from the holes to the upper surface of the HFE due to a difference in specific gravity between the pure water and the HFE. Thus, the pure water is reliably prevented from remaining in the holes.

### BACKGROUND OF THE INVENTION

1. Field of the Invention

The present invention relates to a substrate processing method and a substrate processing apparatus that subject a substrate to predetermined processing.

2. Description of the Background Art

Substrate processing apparatuses have been conventionally used to perform various types of processing on substrates such as semiconductor wafers, glass substrates for photomasks, glass substrates for liquid crystal displays, glass substrates for optical disks or the like.

In a substrate processing apparatus, after a substrate is subjected to a predetermined processing with a chemical liquid, a rinsing process is performed on the substrate by using a rinse liquid such as pure water or the like. Then, the substrate is rotated at a high speed to shake off the rinse liquid remaining on the substrate outwardly by a centrifugal force, so that the substrate is dried (For example, see JP 2006-108349 A).

When the substrate is rotated to shake off the rinse liquid, the direction of the centrifugal force which acts on the rinse liquid on the substrate is limited to a direction from inside to outside the substrate. The rinse liquid exposed on the surface of the substrate horizontally moves to outside the substrate by the centrifugal force, so that the rinse liquid is removed from the substrate.

However, a variety of irregularities such as grooves, holes or the like exist on the substrate, since a circuit pattern is formed on the substrate with various films such as an insulating film, a metallic film, a semiconductor film or the like. Thus, part of the rinse liquid supplied on the substrate enters recesses of the irregularities (hereinafter referred to as holes).

The rinse liquid which entered the holes on the substrate cannot horizontally move to outside the substrate. Therefore, the rinse liquid in the holes remains on the substrate without being shaken off by the centrifugal force.

When the rinse liquid remains on the substrate, it reacts with oxygen in the atmosphere and the surface of the substrate or a metallic substance or the like on the substrate, so that a reaction product is produced on the substrate in some cases. Especially, when pure water is used as the rinse liquid and a silicon substrate is used as the substrate, a watermark is likely to be formed as the reaction product.

Note that there is a method for suppressing production of watermarks by replacing pure water on the substrate with IPA (isopropyl alcohol) after the rinsing process. However, since this method also cannot remove pure water which entered the holes on the substrate, production of watermarks cannot be prevented reliably.

### SUMMARY OF THE INVENTION

An object of the present invention is to provide a substrate processing method and a substrate processing apparatus capable of reliably preventing a rinse liquid from remaining on a substrate.

(1) According to an aspect of the present invention, a substrate processing method includes the steps of supplying a rinse liquid on one surface of a substrate, holding hydrofluoroether on the one surface of the substrate after the supply of the rinse liquid, and removing the hydrofluoroether held on the one surface of the substrate.

In this substrate processing method, the rinse liquid is supplied on the one surface of the substrate, and the hydrofluoroether is subsequently held on the one surface of the substrate. Then, the hydrofluoroether held on the substrate is removed.

The hydrofluoroether is highly volatile compared to a general rinse liquid such as pure water or the like, and has higher specific gravity and lower surface tension than those of the rinse liquid. Moreover, the hydrofluoroether is insoluble in the rinse liquid.

Thus, even though part of the rinse liquid enters holes (concave portions) which exist on the one surface of the substrate when the rinse liquid is supplied, the rinse liquid emerges from the holes to the upper surface of the hydrofluoroether when the hydrofluoroether is held.

The rinse liquid which emerges to the upper surface of the hydrofluoroether is removed from the substrate W together with the hydrofluoroether. Accordingly, the rinse liquid is reliably prevented from remaining on the substrate, and this prevents formation of reaction products such as watermarks or the like.

(2) The step of supplying the rinse liquid may include holding the rinse liquid on the one surface of the substrate, and the step of holding the hydrofluoroether may include replacing the rinse liquid held on the one surface of the substrate with the hydrofluoroether without exposing the one surface of the substrate to outside air.

In this case, an interface of the rinse liquid is not formed on the one surface of the substrate. That is, the three elements of the one surface of the substrate, the rinse liquid and outside air are not brought into contact with one another at a time. This prevents reaction of the three elements, so as to also prevent the formation of the reaction products.

(3) The step of holding the hydrofluoroether may include rotating the substrate around an axis vertical to the substrate while holding the substrate approximately horizontally, and discharging the hydrofluoroether toward the center of the substrate that is rotated.

In this case, the hydrofluoroether spreads over the substrate from the center to the circumference so as to push out the rinse liquid while sinking down into a liquid layer of the rinse liquid. Thus, the rinse liquid held on the one surface of the substrate can be replaced with the hydrofluoroether without exposing the one surface of the substrate to outside air. In addition, since the hydrofluoroether can be held on the one surface of the substrate efficiently, consumption of the hydrofluoroether can be suppressed.

(4) The step of holding the hydrofluoroether may include holding the substrate approximately horizontally, and discharging the hydrofluoroether from a slit-shaped discharge port of a nozzle onto the substrate while moving the nozzle over the surface of the substrate approximately in parallel to the one surface, the length of the discharge port being not smaller than a diameter of the substrate.

In this case, the hydrofluoroether is held from one end to the other end of the one surface of the substrate while the rinse liquid is pushed out from the other end of the one surface of the substrate. Thus, the rinse liquid held on the one surface of the substrate can be replaced with the hydrofluoroether without exposing the one surface of the substrate to outside air.

(5) The substrate processing method may further include the step of applying an ultrasonic vibration to the hydrofluoroether held on the one surface of the substrate.

In this case, even though the rinse liquid is held in the holes and does not easily emerge to the upper surface of the hydrofluoroether, an ultrasonic vibration is applied, so that the rinse liquid is taken out from the holes and emerges to the upper surface of the hydrofluoroether. Accordingly, the rinse liquid can be reliably removed.

(6) The step of removing may include shaking off the hydrofluoroether held on the one surface of the substrate by rotating the substrate.

In this case, the hydrofluoroether is shaken off outwardly from the substrate and removed by a centrifugal force caused by the rotation of the substrate.

(7) The step of removing may include making the hydrofluoroether held on the one surface of the substrate flow downwardly by inclining the substrate.

In this case, unlike the case where the hydrofluoroether is shaken off by the rotation of the substrate, it is not necessary to provide a substrate rotating mechanism for rotating the substrate and a guard for receiving the liquid scattered outwardly from the substrate. Therefore, the apparatus can be reduced in size and weight.

Furthermore, the hydrofluoroether can be integrally removed by surface tension. This prevents fine droplets from remaining on the substrate, and the formation of the reaction products can be prevented more reliably.

Moreover, generation of static electricity and a load to which the substrate is subjected by the centrifugal force are suppressed compared to the case where the substrate is rotated. Thus, the substrate and circuit patterns on the substrate are prevented from being damaged.

Moreover, deformation of the substrate or the like caused by firmly holding the substrate is prevented, since it is not necessary to hold the substrate firmly compared to the case where the substrate W is rotated.

(8) The step of removing may include supplying an inert gas on the substrate.

In this case, the inert gas is supplied on the substrate when the substrate is rotated or inclined, so that the hydrofluoroether can be removed with the area above the substrate being an inert gas atmosphere. Therefore, the substrate can be sufficiently dried while the formation of the reaction products is sufficiently suppressed.

Furthermore, the inert gas is supplied on the substrate after the hydrofluoroether have been removed by rotating or inclining the substrate, so that the hydrofluoroether can be removed more reliably.

(9) A substrate processing apparatus according to another aspect of the present invention includes a substrate holding device that holds a substrate, a rinse liquid supplier that supplies a rinse liquid on one surface of the substrate held by the substrate holding device, a holder that holds hydrofluoroether on the one surface of the substrate held by the substrate holding device, and a removing device that removes the hydrofluoroether held on the one surface of the substrate by the holder.

In this substrate processing apparatus, the rinse liquid is supplied onto the one surface of the substrate held by the substrate holding device by the rinse liquid supplier. Then, the hydrofluoroether is held on the one surface of the substrate by the holder. The hydrofluoroether held on the one surface of the substrate is subsequently removed by the removing device.

In this case, even though part of the rinse liquid enters the holes on the one surface of the substrate when the rinse liquid is supplied, it emerges from the holes to the upper surface of the hydrofluoroether when the hydrofluoroether is being held.

The rinse liquid which have emerged to the upper surface of the hydrofluoroether is removed from the substrate W together with the hydrofluoroether. Accordingly, the rinse liquid is reliably prevented from remaining on the substrate, and the formation of the reaction products such as the watermarks or the like is prevented.

According to the present invention, the rinse liquid is reliably prevented from remaining on the substrate, and the formation of the reaction products such as the watermarks can be prevented.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a plan view of a substrate processing apparatus according to a first embodiment of the present invention;

FIG. 2 is a diagram for use in explaining a configuration of a substrate processing unit in the first embodiment;

FIG. 3 is a diagram for use in explaining operations of the substrate processing unit;

FIG. 4 is a diagram for use in explaining the operations of the substrate processing unit;

FIG. 5 is a diagram for use in explaining the operations of the substrate processing unit;

FIG. 6 is a schematic view for use in explaining effects caused by holding HFE;

FIG. 7 is a diagram for use in explaining a configuration of a substrate processing unit in a second embodiment;

FIG. 8 is a diagram for use in explaining detailed operations of a substrate inclining device;

FIG. 9 is a diagram for use in explaining processing operations of the substrate processing unit in the second embodiment;

FIG. 10 is a diagram for use in explaining the processing operations of the substrate processing unit in the second embodiment;

FIG. 11 is a diagram showing a configuration of a substrate processing unit having an ultrasonic nozzle;

FIG. 12 is a diagram showing an example of an ultrasonic vibration applying device;

FIG. 13 is a diagram showing a slit type-process nozzle;

FIG. 14 is a diagram for use in explaining an example of forming an HFE layer by the slit type-process nozzle; and

FIG. 15 is a diagram for use in explaining an example of removing the HFE layer by using the slit type-process nozzle.

### DESCRIPTION OF THE PREFERRED EMBODIMENTS

A substrate processing method and a substrate processing apparatus according to embodiments of the present invention will now be described with reference to drawings.

In the following description, a substrate refers to a semiconductor wafer, a glass substrate for a liquid crystal display, a glass substrate for a PDP (plasma display panel), a glass substrate for a photomask, a substrate for an optical disk, or the like.

### (1) First Embodiment

### (1-1) Configuration of a Substrate Processing Apparatus

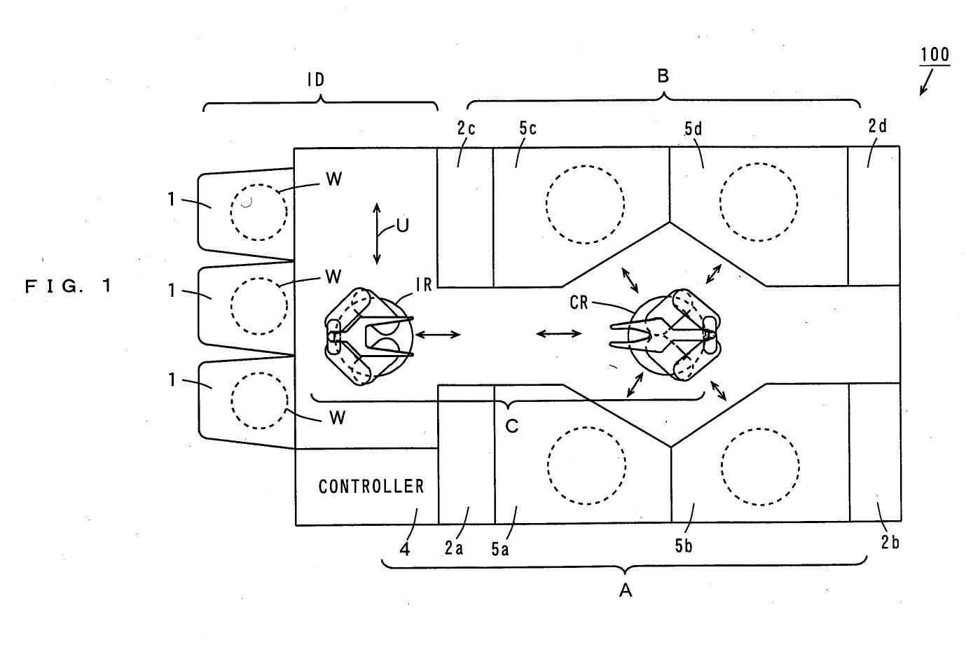

FIG. 1 is a plan view of a substrate processing apparatus according to a first embodiment of the present invention. As shown in FIG. 1, the substrate processing apparatus 100 includes processing regions A, B, and a transporting region C therebetween.

A controller 4, fluid boxes 2a, 2b and substrate processing units 5a, 5b are arranged in the processing region A.

The fluid boxes 2a, 2b in FIG. 1 respectively house fluid-related equipment such as pipes, joints, valves, flow meters, regulators, pumps, temperature controllers, processing liquid storage tanks involved in supply and drain (discharge) a processing liquid (including a chemical liquid, a rinse liquid, and HFE (hydrofluoroether) to be described later) to/from the substrate processing units 5a, 5b.

In the substrate processing units 5a, 5b, a process with the chemical liquid (hereinafter referred to as a chemical liquid process) and a rinsing process are performed on each of the substrates. Furthermore, in the present embodiment, a process by use of the HFE is performed on the substrate after the rinsing process. The details will be described later.

In the processing region B, fluid boxes 2c, 2d and substrate processing units 5c, 5d are arranged. The fluid boxes 2c, 2d and the substrate processing units 5c, 5d respectively have similar structures to those of the above mentioned fluid boxes 2a, 2b and the substrate processing units 5a, 5b. The substrate processing units 5c, 5d respectively perform similar process to that of the substrate processing units 5a, 5b.

Hereinafter, the substrate processing units 5a to 5d will be collectively referred to as processing units. In the transporting region C, a substrate transporting robot CR is provided.

An indexer ID for carrying in and out substrates W is arranged on one end of the processing regions A, B, and an indexer robot IR is provided inside the indexer ID. Carriers 1 that respectively house the substrates W are mounted on the indexer ID.

The indexer robot IR in the indexer ID moves in a direction of an arrow U to take out the substrate W from the carrier 1 and transfer the substrate W to the substrate transporting robot CR. Conversely, the indexer robot IR receives the substrate W subjected to a series of processes from the substrate transporting robot CR and returns it to the carrier 1.

The substrate transporting robot CR transports the substrate W transferred from the indexer robot IR to a specified processing unit, or transports the substrate W received from the processing unit to another processing unit or to the indexer robot IR.

In the present embodiment, after processing is performed on the substrate W in any of the substrate processing units 5a to 5d, the substrate W is carried out from the substrate processing units 5a to 5d by the substrate transporting robot CR, and carried into the carrier 1 by the indexer robot IR.

The controller 4 is composed of a computer or the like including a CPU (central processing unit), and controls the operation of each of the processing units in the processing regions A, B, the operation of the substrate transporting robot CR in the transporting region C and the operation of the indexer robot IR in the indexer ID.

### (1-2) Configuration of the Substrate Processing Unit

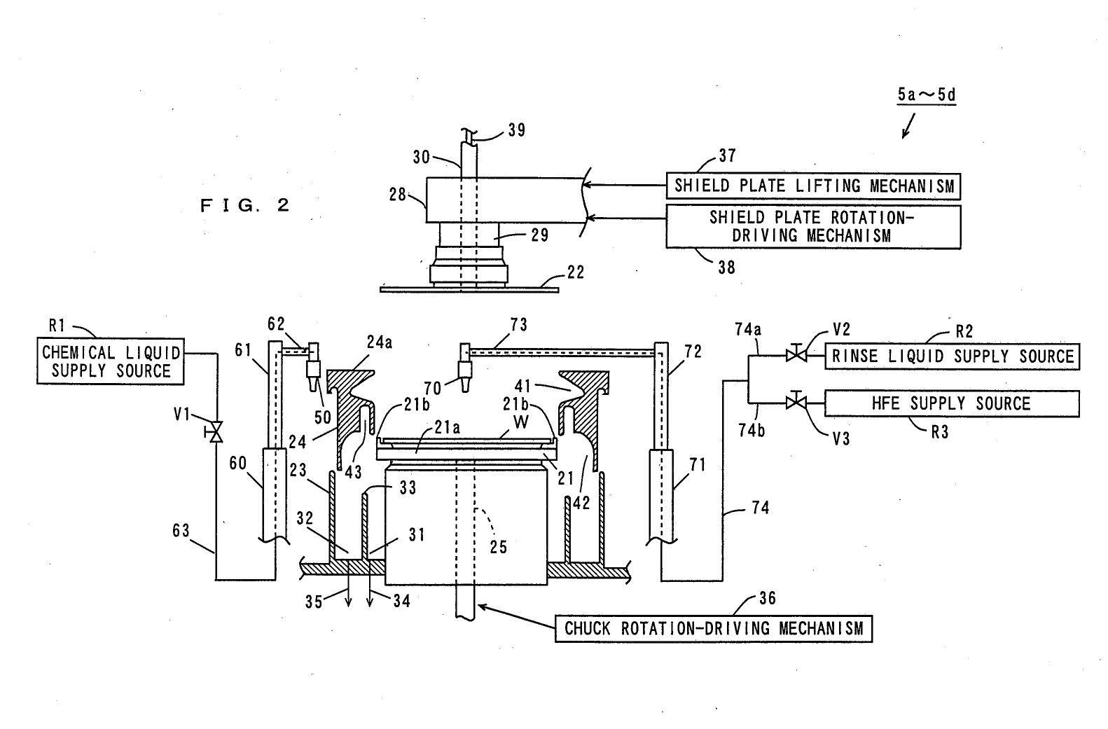

FIG. 2 is a diagram for use in explaining the configuration of the substrate processing units 5a to 5d in the substrate processing apparatus 100 according to the present embodiment.

The substrate processing units 5a to 5d of FIG. 2 remove impurities such as organic substances or the like adhering to the surface of the substrate W by the chemical liquid process, and subsequently perform the rinsing process and a drying process for the substrate W.

As shown in FIG. 2, the substrate processing unit 5a to 5d is provided with a spin chuck 21 for holding the substrate W horizontally while rotating the substrate W around a vertical rotation shaft passing through the center of the substrate W. The spin chuck 21 includes a spin base 21a and a plurality of holding pins 21b that hold the substrate W on the spin base 21a. The spin chuck 21 is secured on an upper end of the rotation shaft 25, which is rotated by a chuck rotation-driving mechanism 36.

A motor 60 is provided outside the spin chuck 21. A rotation shaft 61 is connected to the motor 60. An arm 62 is coupled to the rotation shaft 61 so as to extend in a horizontal direction, and has a chemical liquid process nozzle 50 on its tip.

The motor 60 causes the rotation shaft 61 to rotate, and also the arm 62 to turn, so that the chemical liquid process nozzle 50 moves to above the substrate W held by the spin chuck 21.

A chemical liquid supply pipe 63 is provided so as to pass through the inside of the motor 60, the rotation shaft 61 and the arm 62. The chemical liquid supply pipe 63 is connected to a chemical liquid supply source R1 provided outside the substrate processing apparatus 100 or in the fluid boxes 2a to 2d of FIG. 1. A valve V1 is inserted in the chemical liquid supply pipe 63.

Opening the valve V1 causes a chemical liquid to be supplied from the chemical liquid supply source R1 to the chemical liquid process nozzle 50 through the chemical liquid supply pipe 63. Accordingly, the chemical liquid can be supplied to the surface of the substrate W.

As the chemical liquid, BHF (buffered hydrofluoric acid), DHF (diluted hydrofluoric acid), hydrofluoric acid, hydrochloric acid, sulfuric acid, nitric acid, phosphoric acid, acetic acid, oxalic acid, ammonia or the like, or a mixture thereof are used.

A motor 71 is provided outside the spin chuck 21. The motor 71 is connected to a rotation shaft 72, which is coupled to an arm 73. A rinsing process nozzle 70 is provided on the tip of the arm 73.

The motor 71 causes the rotation shaft 72 to rotate, and also the arm 73 to turn, so that the rinsing process nozzle 70 moves to above the substrate W held by the spin chuck 21.

A rinsing process supply pipe 74 is provided so as to pass through the inside of the motor 71, the rotation shaft 72 and the arm 73. The rinsing process supply pipe 74 branches into a rinse liquid pipe 74a and an HFE pipe 74b, which are respectively connected to a rinse liquid supply source R2 and an HFE supply source R3 provided outside the substrate processing apparatus 100 or in the fluid boxes 2a to 2d of FIG. 1. Valves V2 and V3 are inserted in the rinse liquid pipe 74a and the HFE pipe 74b, respectively.

Opening the valve V2 causes a rinse liquid to be supplied from the rinse liquid supply source R2 to the rinsing process nozzle 70 through the rinse liquid pipe 74a and the rinsing process supply pipe 74, and opening the valve V3 causes HFE to be supplied from the HFE supply source R3 to the rinsing process nozzle 70 through the HFE pipe 74b and the rinsing process supply pipe 74. Thus, the rinse liquid or HFE can alternatively be supplied to the surface of the substrate W. In the present embodiment, pure water is used as the rinse liquid. Details of HFE will be described later.

When the chemical liquid is supplied onto the substrate W, the chemical liquid process nozzle 50 moves to a processing position above the center of the substrate W, and the rinsing process nozzle 70 is retracted to a waiting position outside the substrate W. When pure water is supplied onto the substrate W, the chemical liquid process nozzle 50 is retracted to a waiting position outside the substrate W, and the rinsing process nozzle 70 moves to the processing position above the center of the substrate W.

The spin chuck 21 is housed in a processing cup 23. A cylindrical partition wall 33 is provided inside the processing cup 23. A drain space 31 to discard the processing liquid used for processing the substrate W is formed so as to surround the spin chuck 21. Furthermore, a liquid recovery space 32 for recovering the processing liquid used for processing the substrate W is formed between the processing cup 23 and the partition wall 33 so as to surround the drain space 31.

A drain pipe 34 for leading the processing liquid to a drain processing device (not shown) is connected to the drain space 31, and a recovery pipe 35 for leading the processing liquid to a recovery processing device (not shown) is connected to the liquid recovery space 32.

Above the processing cup 23, a guard 24 is provided to prevent the processing liquid from being scattered outwardly from the substrate W. This guard 24 has a rotation symmetric shape with respect to the rotation shaft 25. In the inner surface of the upper end of the guard 24, a drain guiding groove 41 having a V-shaped cross section is annularly formed.

In the inner surface of the lower end of the guard 24, a recovery liquid guide 42 having an inclined face, which inclines down outwardly is formed. In the vicinity of the upper end of the recovery liquid guide 42, a partition wall-housing groove 43 for receiving the partition wall 33 of the processing cup 23 is formed.

This guard 24 is provided with a guard lifting mechanism composed of a ball screw mechanism or the like (not shown). The guard lifting mechanism moves the guard 24 upward and downward between a recovery position in which the recovery liquid guide 42 faces an outer circumference of the substrate W held by the spin chuck 21 and a drain position in which the drain guiding groove 41 faces the outer circumference of the substrate W held by the spin chuck 21. When the guard 24 is in the recovery position, the processing liquid scattered outwardly from the substrate W is led to the recovery liquid space 32 by the recovery liquid guide 42 and recovered through the recovery pipe 35. On the other hand, when the guard 24 is in the drain position, the processing liquid scattered outwardly from the substrate W is led to the drain space 31 by the drain guiding groove 41 and discarded through the drain pipe 34. With the above described configuration, the processing liquid is discarded and recovered.

Note that when the substrate W is carried to and from the spin chuck 21, the guard lifting mechanism retracts the guard 24 further downwardly from the drain position, and moves the guard 24 so that an upper end 24a of the guard 24 is in a position lower than a level where the substrate W is held by the spin chuck 21.

A disk-shaped shield plate 22 having an opening in the center thereof is provided above the spin chuck 21. A support shaft 29 is provided vertically in the downward direction from the vicinity of the tip of an arm 28, and the shield plate 22 is fixed to the lower end of the support shaft 29 so as to face the upper surface of the substrate W held by the spin chuck 21.

Inside the support shaft 29, a nitrogen gas supply path 30 which communicates with the opening of the shield plate 22 is inserted. A nitrogen gas (N₂) is supplied to the nitrogen gas supply path 30.

The arm 28 is connected to a shield plate lifting mechanism 37 and a shield plate rotation-driving mechanism 38. The shield plate lifting mechanism 37 moves the shield plate 22 upward and downward between a position in which the shield plate 22 is close to the upper surface of the substrate W held by the spin chuck 21 and a position in which the shield plate 22 is away upwardly from the spin chuck 21. The shield plate rotation-driving mechanism 38 rotates the shield plate 22 in the same direction as that of the substrate W.

### (1-2-a) Details of HFE

HFE will now be described. As examples of HFE, C₄F₉OCH₃ (hereinafter referred to as a first HFE), C₄F₉OC₂H₅ (hereinafter referred to as a second HFE), and C₅F₁₃OCH₃ (hereinafter referred to as a third HFE) are given.

HFE has a lower boiling point, higher specific gravity (density) and lower surface tension than those of pure water. Moreover, HFE is insoluble in pure water. In contrast, IPA (isopropyl alcohol) has lower specific gravity than that of pure water and is arbitrarily blended with pure water. Note that the first HFE and the second HFE have lower boiling points and lower surface tension than those of IPA.

For example, the boiling point, density and surface tension of the first HFE are 61° C., 1520 kg/m³ and 14 mN/m, respectively. In contrast, those of pure water are 100° C., 1000 kg/m³ and 73 mN/m, respectively. Those of IPA are 82.4° C., 786 kg/m³ and 21 mN/m, respectively. The solubility of the first HFE to pure water is as very small as 12 ppm.

Instead of HFE, a liquid mixture containing HFE as a component, for example, a mixture of the first HFE and trans-1, 2-dichloroethylene whose ratio of components is 50:50, a mixture of the first HFE, trans-1, 2-dichloroethylene and ethanol whose ratio of components is 52.7:44.6:2.7, a mixture of the first HFE and IPA whose ratio of components is 95:5, or the like may be used.

These liquid mixtures each have substantially the same properties as those of the first HFE, the second HFE and the third HFE mentioned above, have higher specific gravity (density) and lower surface tension than those of pure water, and are insoluble in pure water. These liquid mixtures are less soluble in pure water compared to IPA.

### (1-3) Operation of the Substrate Processing Apparatus

A processing operation of the substrate processing unit 5a to 5d having the above configuration will be described. First, when the substrate W is carried in, the substrate transporting robot CR (FIG. 1) mounts the substrate W on the spin chuck 21 while the guard 24 is lowered. The substrate W mounted on the spin chuck 21 is held by the spin chuck 21.

Next, the chemical liquid process nozzle 50 moves from the waiting position to the processing position above the center of the substrate W while the guard 24 is lifted to the recovery position or the drain position mentioned above. In this state, the rotation shaft 25 rotates, causing the substrate W held on the spin chuck 21 to rotate accordingly. Then, the chemical liquid is supplied from the chemical liquid process nozzle 50 onto the substrate W. In this way, the chemical liquid process is performed on the substrate W.

After the elapse of a predetermined time, the supply of the chemical liquid from the chemical liquid process nozzle 50 is stopped, and the chemical liquid process nozzle 50 moves to the waiting position outside the substrate W.

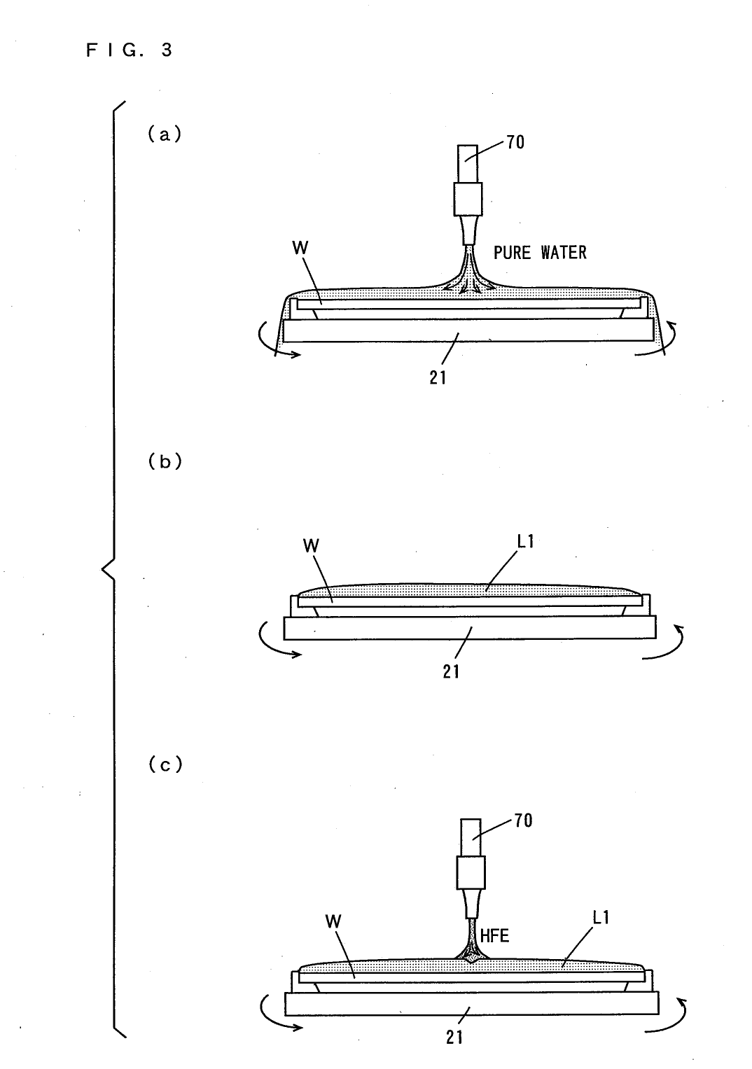

The operation of the substrate processing unit 5a to 5d after the chemical liquid process is described with reference to FIGS. 3 to 6. FIGS. 3 to 5 are diagrams for use in explaining the operation of the substrate processing unit 5a to 5d after the chemical liquid process.

After the chemical liquid process, first, the rinsing process nozzle 70 moves to above the substrate W, and pure water is supplied from the rinsing process nozzle 70 onto the substrate W as shown in FIG. 3 (a). Thus, the substrate W is subjected to the rinsing process, and the chemical liquid remaining on the substrate W, residues of an organic film and the like produced by the chemical liquid process are washed away.

After the elapse of a predetermined time, a rotation speed of the rotation shaft 25 (FIG. 2) decreases to 10 to 50 rpm, for example. Accordingly, the amount of pure water which is shaken off by the rotation of the substrate W decreases, so that the pure water is held on the substrate W by surface tension. As a result, as shown in FIG. 3(b), a liquid layer of the pure water (hereinafter referred to as the pure water layer) L1 is formed on the substrate W. Then, the supply of the pure water is stopped. Note that the pure water may be held on the substrate W after the rotation of the rotation shaft 25 is stopped.

Next, HFE is supplied from the rinsing process nozzle 70 to the center of the pure water layer L1 on the substrate W as shown in FIG. 3 (c) while the rotation shaft 25 rotates at a low rotation speed (10 to 50 rpm, for example).

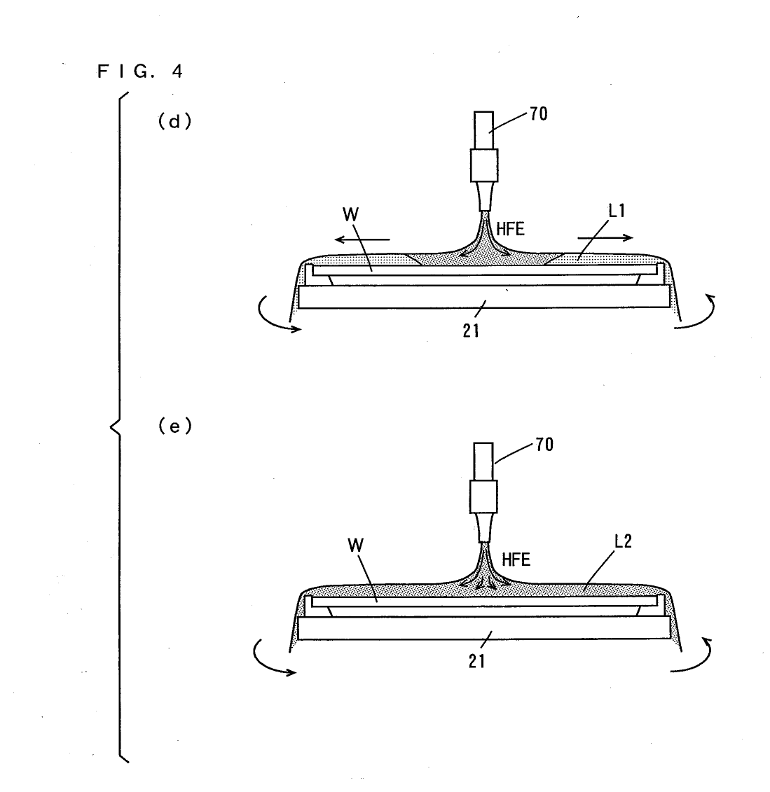

As mentioned above, HFE has low solubility in pure water, and higher specific gravity than that of pure water. Furthermore, a centrifugal force directed toward the outside of the substrate W acts on the HFE and the pure water layer L1. Therefore, as shown in FIG. 4(d), the HFE spreads over the substrate W from the center to the circumference while sinking down into the pure water layer L1. Accordingly, the pure water layer L1 is pushed out from the circumference of the substrate W.

As a result, as shown in FIG. 4 (e), the pure water layer L1 is removed from the substrate W while the HFE is held on the substrate W without exposing the surface of the substrate W to the atmosphere. That is, the pure water layer L1 on the substrate W is replaced by a liquid layer of the HFE (hereinafter referred to as the HFE layer) L2.

The supply of the HFE and the rotation of the rotation shaft 25 are continued for a predetermined period of time (5 seconds to 120 seconds, for example). Note that the supply amount of the HFE after the formation of the HFE layer L2 may be smaller than that of the HFE during the formation of the HFE layer L2. Then, the supply of the HFE is stopped, and the rinsing process nozzle 70 is retracted to the waiting position outside the substrate W.

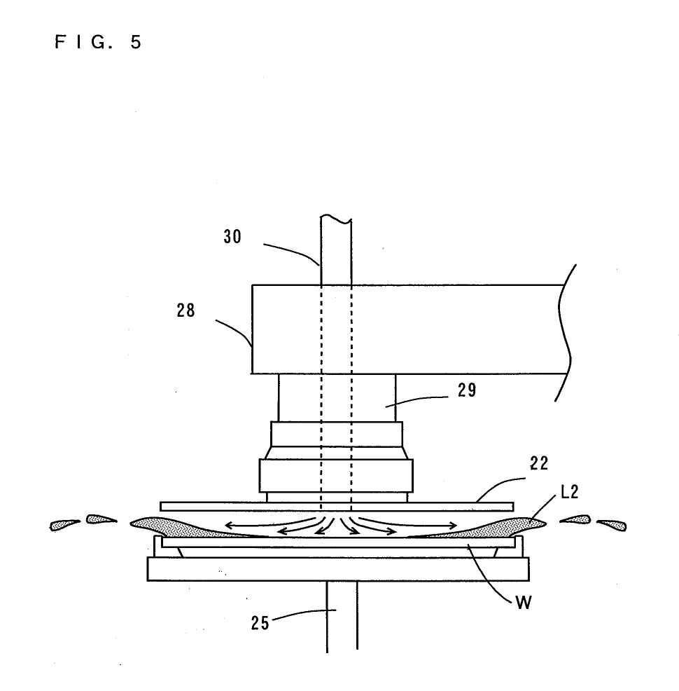

Next, as shown in FIG. 5, the shield plate 22 is lowered to a position close to the substrate W. In this state, the rotation speed of the rotation shaft 25 increases while a nitrogen gas is supplied between the substrate W and the shield plate 22 through the gas supply path 30. The shield plate 22 rotates in the same direction as that of the substrate W.

In this case, the HFE layer L2 is shaken off outwardly from the substrate W by a centrifugal force caused by the rotation of the substrate W with the space between the substrate W and the shield plate 22 being a nitrogen atmosphere. Therefore, the substrate W can be dried while formation of reaction products is sufficiently suppressed. Also, a nitrogen gas flow from the center of the substrate W to the outside is formed, thereby reliably pushing the HFE on the substrate W to the outside of the substrate W.

Then, the rotation of the rotation shaft 25 is stopped while the shield plate 22 moves apart from the substrate W. The substrate transporting robot CR of FIG. 1 subsequently carries the substrate W out of the substrate processing unit 5a to 5d while the guard 24 is lowered.

Note that although the HFE layer L2 is being shaken off while the nitrogen gas is supplied between the substrate W and the shield plate 22 in this embodiment, the shield plate 22 may move close to the substrate W after the HFE layer L2 on the substrate W is shaken off and the nitrogen gas is supplied between the substrate W and the shield plate 22.

In this case, even though the HFE layer L2 is not completely removed from the substrate W after being shaken off by the rotation, the nitrogen gas is subsequently supplied, so that the HFE layer L2 remaining on the substrate Wis reliably removed.

Note that since HFE is highly-volatile compared to pure water and spontaneously evaporates at room temperature within a relatively short time, the supply of the above mentioned nitrogen gas is not always necessary.

If the HFE and the pure water removed from the substrate W are recovered and stored in a recovery tank which is not shown, the HFE and the pure water will phase-separate in the recovery tank. In this case, it is possible to reuse only the HFE while discarding supernatant pure water from the recovery tank.

### (1-4) Effects Caused by Forming the HFE Layer

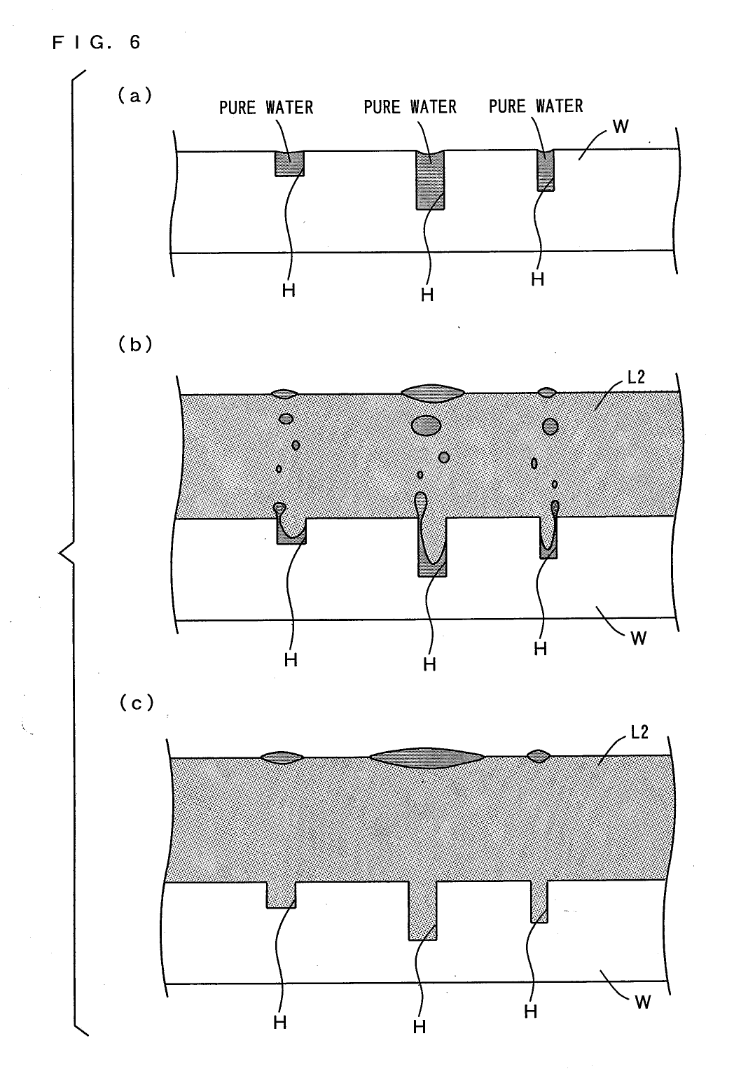

Effects caused by holding the HFE on the substrate W after rinsing process of the substrate W will now be described. FIG. 6 is a schematic view for use in explaining the effects caused by holding the HFE on the substrate W.

As shown in FIG. 6(a), holes H having a variety of shapes exist on the surface of the actual substrate W. The holes H are grooves between circuit patterns, through holes or the like, for example. When the pure water is supplied onto the substrate W during the rinsing process, part of the pure water enters the holes H. In a case where the holes H have a concave shape which is approximately vertical to the surface of the substrate W, the pure water which have entered the holes H can be hardly shaken off even though the substrate W is rotated at a high speed. Therefore, conventionally, the pure water has been likely to remain in the holes H, and this has become a cause of watermark formation.

In the present embodiment, the HFE is held on the substrate W to form the HFE layer L2 after the rinsing process. In this case, as shown in FIG. 6 (b) and FIG. 6 (c), the HFE enters the holes H while the pure water emerges from the holes H to the upper surface of the HFE layer L2 due to a difference in specific gravity between the pure water and the HFE. Accordingly, the pure water is reliably prevented from remaining in the holes H. Also, since the HFE has low surface tension, it easily enters the holes H.

Note that since the pure water has high surface tension, it is held in the holes H so as not to easily emerge to the upper surface of the HFE layer in some cases. Thus, in the present embodiment, the supply of the HFE and the rotation of the rotation shaft 25 are continued for a predetermined period of time even after the HFE layer L2 has been formed.

In this case, the pure water is taken out from the holes H by a physical force caused by the HFE flow and the rotation of the substrate W, and emerges to the upper surface of the HFE layer L2. Note that the period of time for which the supply of the HFE and the rotation of the rotation shaft 25 are continued after the formation of the HFE layer L2 may suitably be changed depending on the number and sizes of the holes H.

The HFE enters the holes H instead of the pure water, but can be removed with comparative ease in the subsequent drying process, since the HFE is highly volatile and has low surface tension compared to the pure water. Even though the HFE remains in the holes H, it is not likely to become a cause of the reaction products such as the watermarks or the like, since it spontaneously evaporates in a short time.

In the case where the pure water in the holes H can emerge to the upper surface of the HFE layer L2 with comparative ease for reasons such as the smaller number of holes H, shallower depth of holes H or the like, the supply of the HFE and the rotation of the rotation shaft 25 may be stopped after the formation of the HFE layer L2 to keep the HFE layer L2 held on the substrate W by the surface tension. In this case, consumption of the HFE can be suppressed.

In the case where the same process is performed by use of IPA (isopropyl alcohol) instead of HFE, the pure water in the holes H does not emerge on the IPA, since the IPA has lower specific gravity than that of the pure water. Therefore, the pure water remains in the holes H, so that the formation of the watermarks cannot be prevented. Moreover, it is difficult to completely replace the pure water on the substrate W by a liquid layer of the IPA, since the IPA is more soluble in the pure water than the HFE.

### (1-5) Effects of the First Embodiment

In the first embodiment, a state where the HFE layer L2 is formed on the substrate W after the rinsing process is maintained temporarily. In this case, the pure water becomes easily removable from the substrate W, since the pure water which entered the holes H of the substrate W emerges to the upper surface of the HFE layer L2. Thus, the pure water can be reliably prevented from remaining on the substrate W.

In the first embodiment, the pure water layer L1 is formed on the substrate W, and the HFE is subsequently supplied onto the substrate W, with the pure water layer L1 being held on the substrate W, so that the HFE layer L2 is formed. In this case, since the HFE layer L2 is formed without exposing the surface of the substrate W to the atmosphere after the rinsing process, oxygen in the atmosphere, the pure water and the surface of the substrate W are prevented from reacting with one another during the process, resulting in prevention of the watermark formation.

In the first embodiment, at the time of formation of the HFE layer L2, the HFE is supplied toward the center of the substrate W while the substrate W on which the pure water layer L1 is held is rotated at a low rotation speed. In this case, the HFE layer L2 can be efficiently formed from the center to the circumference of the substrate W while pushing the pure water layer L1 to the outside of the substrate W. Accordingly, the consumption of the HFE can be suppressed.

In the first embodiment, the HFE layer L2 is formed while the supply of the HFE and the rotation of the rotation shaft 25 are maintained. Therefore, the pure water can reliably be taken out from the holes H by the physical force caused by the HFE flow and the rotation of the substrate W.

### (2) Second Embodiment

A substrate processing apparatus according to a second embodiment of the present invention will be described. The substrate processing apparatus according to the second embodiment is provided with substrate processing units 5e to 5h to be shown below instead of the substrate processing units 5a to 5d shown in FIG. 2.

### (2-1) Configuration of the Substrate Processing Unit

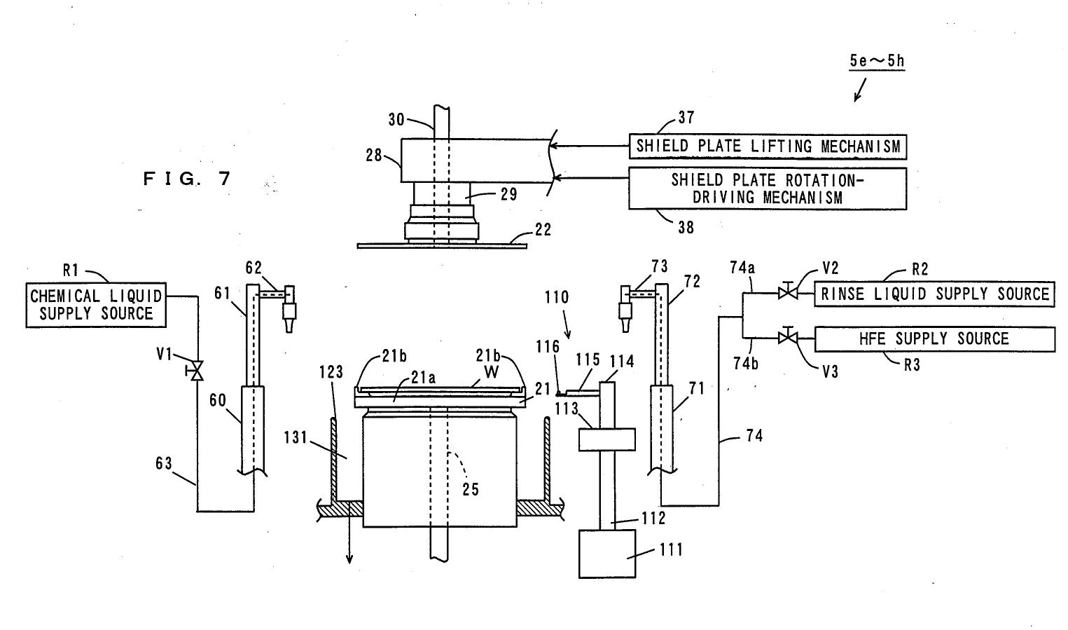

FIG. 7 is a diagram for use in explaining a configuration of the substrate processing unit 5e to 5h. For the substrate processing unit 5e to 5h, different points from the substrate processing unit 5a to 5d (see FIG. 2) will be described below.

As shown in FIG. 7, a guard 24 and a chuck rotation-driving mechanism 36 are not provided in the substrate processing unit 5e to 5h.

In addition, in this substrate processing unit 5e to 5h, a processing cup 123 is provided instead of the processing cup 23. A drain recovery space 131 is formed inside the processing cup 123 for discarding or recovering the processing liquid used for processing the substrate W.

Also, a substrate inclining device 110 is provided outside a spin chuck 21. The substrate inclining device 110 is provided with a lifting device 111. The lifting device 111 is connected to a lifting shaft 112, and a motor 113 is attached to an upper end of the lifting shaft 112. A rotation shaft 114 is provided so as to extend upwardly from the motor 113, and an inclining arm 115 extending horizontally is coupled to the rotation shaft 114. A substrate supporting member 116 is provided on an upper surface of the tip of the inclining arm 115.

The lifting shaft 112 is moved upward and downward by the lifting device 111, causing the motor 113, the rotation shaft 114 and the inclining arm 115 to move upward and downward accordingly. Also, the motor 113 rotates the rotation shaft 114, causing the inclining arm 115 to turn accordingly.

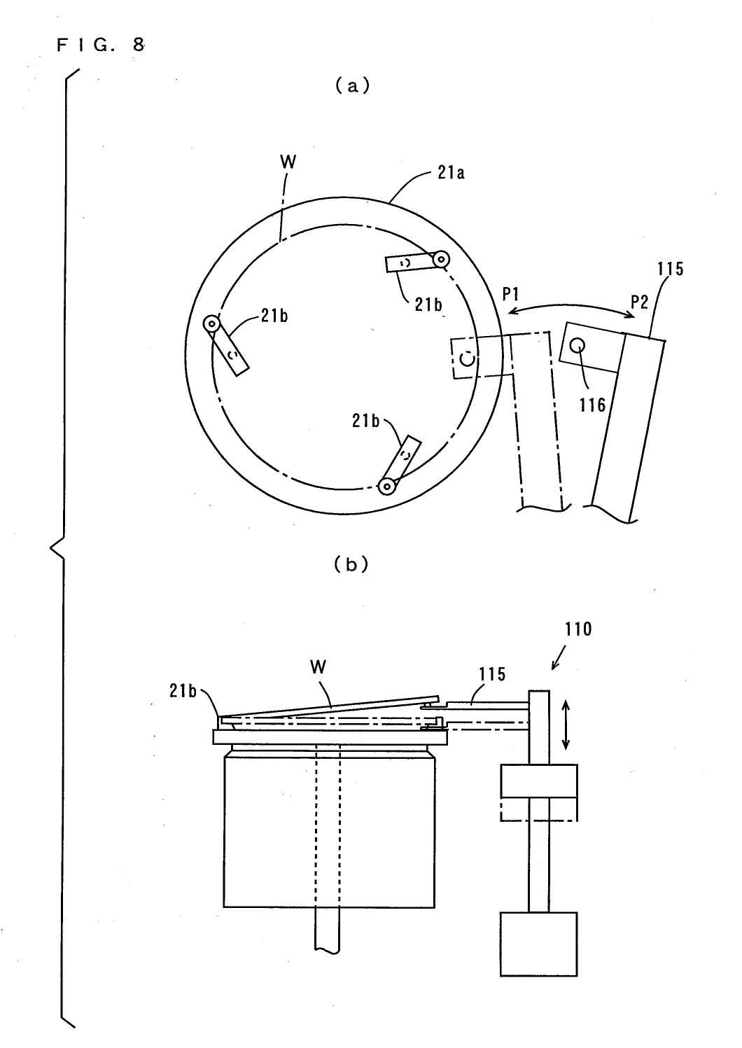

Detailed operations of the substrate inclining device 110 will now be described with reference to FIG. 8. FIG. 8 is a diagram for use in explaining the detailed operations of the substrate inclining device 110.

As shown in FIG. 8(a), the inclining arm 115 has an approximate L-shape and turns between a substrate inclining position P1 in which the substrate supporting member 116 is positioned between a substrate W and the spin chuck 21 and a waiting position P2 in which the substrate supporting member 116 is positioned outside the spin chuck 21.

The inclining arm 115 moves upward at the substrate inclining position P1, so that one side of the substrate W is lifted up, and the substrate W takes an inclined posture as shown in FIG. 8 (b).

Note that positions of holding pins 21b are adjusted not to prevent the movement of the inclining arm 115 and to be able to support the lower end of the substrate W in the inclined posture, when the inclining arm 115 moves from the waiting position to the substrate inclining position, and when the inclining arm 115 is lifted up at the substrate inclining position.

### (2-2) Operations of the Substrate Processing Apparatus

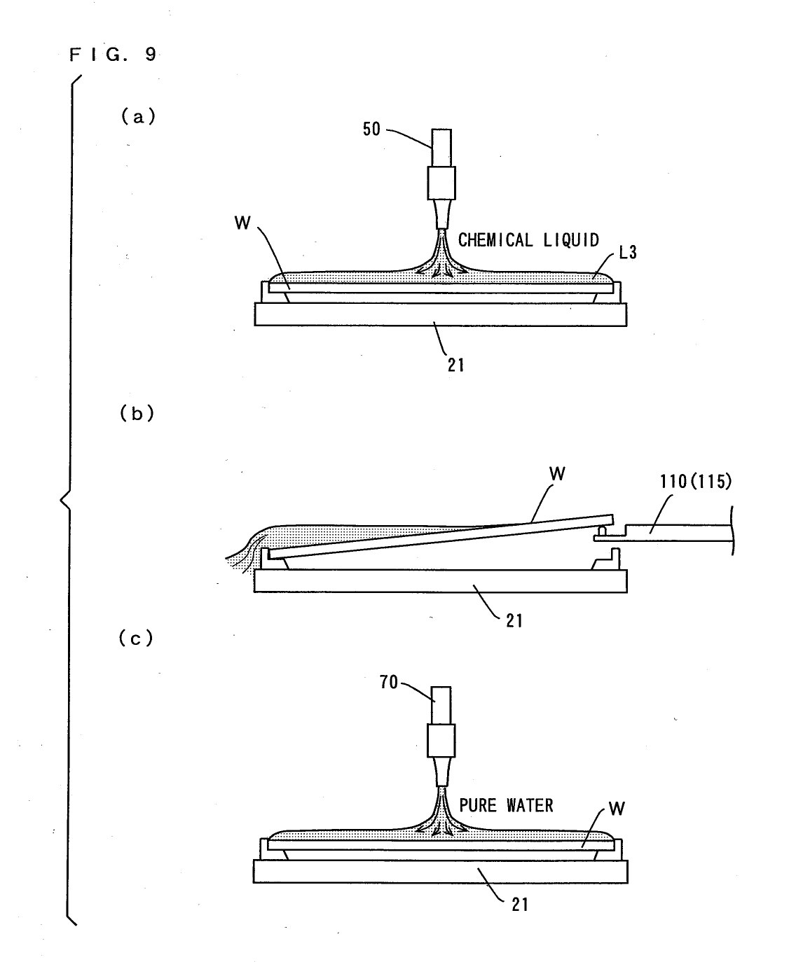

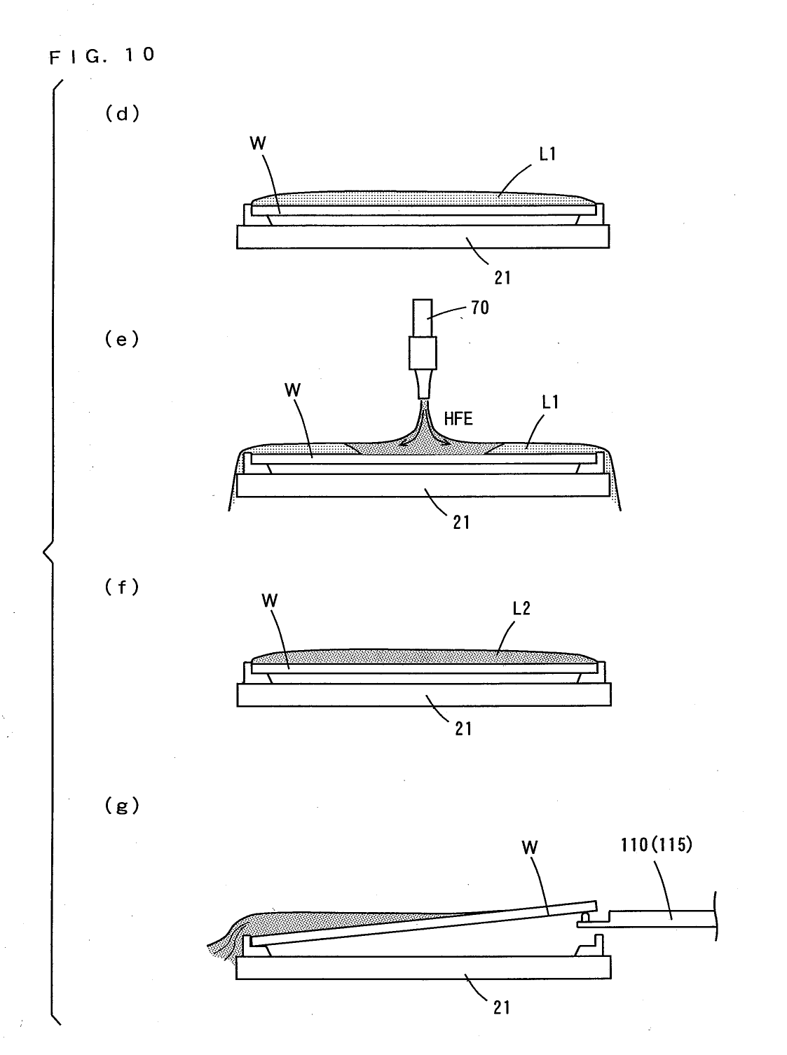

Processing operations of the substrate processing unit 5e to 5h shown in FIG. 7 will be subsequently described. FIG. 9 and FIG. 10 are diagrams for use in explaining the processing operations of the substrate processing unit 5e to 5h.

First, the substrate W is mounted on the spin chuck 21, similarly to the above first embodiment. Then, as shown in FIG. 9 (a), a chemical liquid is supplied from a chemical liquid process nozzle 50 onto the substrate W. The chemical liquid is continuously supplied, so that the chemical liquid is held over the whole upper surface of the substrate W to form a liquid layer of the chemical liquid (hereinafter referred to as the chemical liquid layer) L3.

Then, the chemical liquid process nozzle 50 moves to the waiting position outside the substrate W, and the substrate having the chemical liquid layer L3 held thereon is maintained for a predetermined period of time. Accordingly, the chemical liquid process is performed on the surface of the substrate W.

After the elapse of a predetermined period of time, as shown in FIG. 9 (b), the substrate inclining device 110 causes the substrate W to take the inclined posture. Thus, the chemical liquid layer L3 on the substrate W flows downwardly along the inclination to be removed from the substrate W.

The substrate W subsequently returns to a horizontal posture, and the rinsing process nozzle 70 moves to above the substrate W. Then, as shown in FIG. 9(c), pure water is supplied from the rinsing process nozzle 70 to the substrate W. In this way, the chemical liquid remaining on the substrate W and residues of an organic film produced by the chemical liquid process or the like are washed away. Then, the supply of the pure water is stopped, and the pure water is held on the substrate W to form a pure water layer L1 as shown in FIG. 10 (d).

Next, as shown in FIG. 10 (e), HFE is supplied from the rinsing process nozzle 70 onto the substrate W. In this case, the HFE is continuously supplied to gradually sink down into the pure water layer L1, so that the pure water layer L1 spills out to the outside of the substrate W. Accordingly, the pure water layer L1 on the substrate W is replaced with an HFE layer L2.

As shown in the first embodiment above, the HFE layer L2 is formed on the substrate W after the rinsing process, so that the pure water which entered holes H of the substrate W (see FIG. 6) emerges to the upper surface of the HFE layer L2.

After the elapse of a predetermined period of time, as shown in FIG. 10 (g), the substrate W is again brought to take the inclined posture by the substrate inclining device 110. Thus, the HFE layer L2 on the substrate W flows downwardly along the inclination, so that the HFE layer L2 is removed from the substrate W. Also, the pure water which emerged from the holes H is removed from the substrate W together with the HFE layer L2.

Then, a shield plate 22 is lowered to a position close to the substrate W and a nitrogen gas is supplied between the substrate W and the shield plate 22 through a gas supply path 30. Accordingly, the HFE remaining on the substrate W is sufficiently removed, so that the substrate W is dried.

Note that the nitrogen gas may be supplied through the gas supply path 30 during a period in which the substrate W is in the inclined posture so that the HFE layer L2 flows downwardly. In this case, an area above the substrate W becomes a nitrogen gas atmosphere, so that formation of reaction products on the substrate W can be suppressed.

### (2-3) Effects of the Second Embodiment

In the second embodiment, the substrate W is inclined by the substrate inclining device 110, so that the processing liquid (including the chemical liquid, the pure water and the HFE) is removed from the substrate W. In this case, unlike the case where the processing liquid is shaken off by the rotation of the substrate W, a substrate rotation mechanism for rotating the substrate W and a guard for receiving the processing liquid scattered to the outside of the substrate W may not be provided. Therefore, the substrate processing unit 5e to 5h can be reduced in size and weight. Also, this makes it possible to provide another process mechanism in a space for the substrate rotation mechanism and the guard.

Furthermore, in the second embodiment, the HFE layer L2 integrally flows downwardly from the substrate W by surface tension when the substrate W is inclined. This prevents fine droplets from remaining on the substrate W. Accordingly, the formation of the reaction products on the substrate W can be prevented more reliably.

Moreover, in the second embodiment, the substrate W is not rotated at a high speed, therefore the substrate W is not subjected to a load caused by a centrifugal force. Also, this prevents generation of static electricity caused by the rotation of the substrate W. Thus, the substrate W and circuit patterns on the substrate W are prevented from being damaged.

Additionally, in the second embodiment, it is not necessary to hold the substrate W firmly compared to the case where the substrate W is rotated. Therefore, the configuration of the spin chuck 21 can be simplified. Moreover, deformation of the substrate W caused by holding the substrate W firmly is also prevented.

### (3) Other Embodiments

### (3-1)

While the HFE is supplied onto the substrate W by use of the rinsing process nozzle 70 in the first and second embodiments described above, the HFE may be supplied onto the substrate W by use of an ultrasonic nozzle which will be shown below instead of the rinsing process nozzle 70.

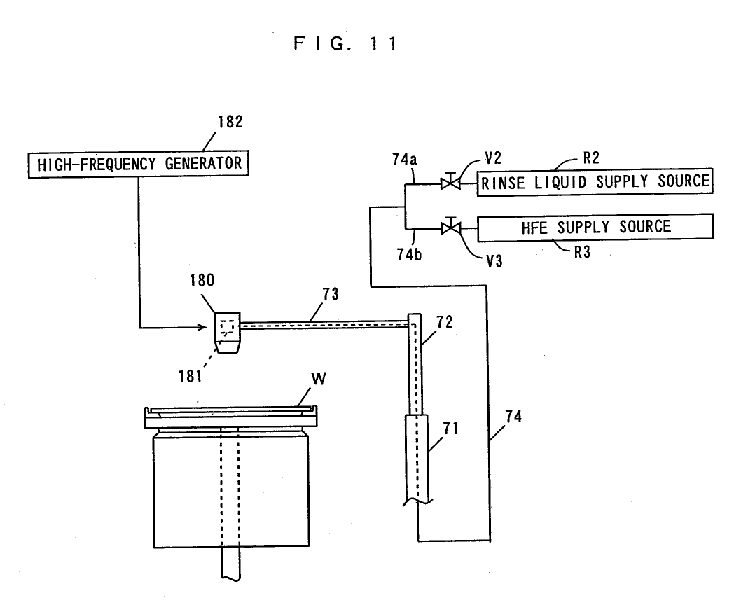

FIG. 11 is a diagram showing a configuration of the substrate processing unit 5a to 5d (5e to 5h) having the ultrasonic nozzle. As shown in FIG. 11, an ultrasonic nozzle 180 instead of the rinsing process nozzle 70 is attached on the tip of the arm 73. Note that the other configurations of the substrate processing unit 5a to 5d (5e to 5h) are the same as those shown in the FIG. 2 or FIG. 7, although they are omitted in FIG. 11.

The rinsing process supply pipe 74 is connected to the ultrasonic nozzle 180, and opening the valves V2, V3 enables pure water or HFE to be selectively supplied to the surface of the substrate W, similarly to the examples of FIG. 2 and FIG. 7.

In addition, a high-frequency vibrator 181 is incorporated in the ultrasonic nozzle 180. The high-frequency vibrator 181 is electrically connected with a high-frequency generator 182.

When the HFE is supplied onto the substrate W, a high-frequency current is supplied from the high-frequency generator 182 to the high-frequency vibrator 181. Accordingly, the high-frequency vibrator 181 ultrasonically vibrates, so that the HFE passing through the ultrasonic nozzle 180 is brought in an ultrasonic vibration state.

In this case, the HFE being in the ultrasonic vibration state is supplied from the ultrasonic nozzle 180 to the substrate W. Accordingly, the pure water can be reliably taken out from the holes H by the ultrasonic vibration, even though it is held in holes H on the substrate by surface tension.

### (3-2)

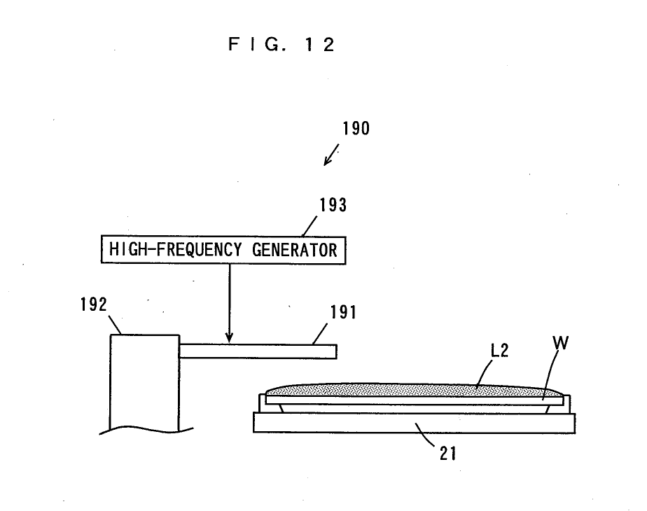

An ultrasonic vibration applying device that applies an ultrasonic vibration to the HFE layer L2 formed on the substrate W may be provided. FIG. 12 is a diagram showing an example of the ultrasonic vibration applying device.

As shown in FIG. 12, an ultrasonic applying device 190 includes a bar-shaped high-frequency vibrator 191, a vibrator moving mechanism 192 that moves the high-frequency vibrator 191 vertically and horizontally, and a high-frequency generator 193 that supplies the high-frequency current to the high-frequency vibrator 191.

After the HFE layer L2 is formed on the substrate W, the high-frequency vibrator 191 is moved to a position where it is in contact with the HFE layer L2 on the substrate by the vibrator moving mechanism 192. In this state, the high-frequency current is supplied from the high-frequency generator 193 to the high-frequency vibrator 191, so that the high-frequency vibrator 191 ultrasonically vibrates to apply the ultrasonic vibration to the HFE layer L2 on the substrate W. The ultrasonic vibration enables the pure water to be taken out from the holes H on the substrate W.

### (3-3)

The high-frequency vibrator that applies the ultrasonic vibration to the HFE layer L2 may be provided on the back surface (lower surface) of the substrate W. For example, the high-frequency vibrator is secured on an upper surface of a spin base 21a (in FIG. 2 and FIG. 7) and a liquid is filled between the lower surface of the substrate W and the upper surface of the spin base 21a, so that the ultrasonic vibration of the high-frequency vibrator can be transmitted to the substrate W via the liquid. The ultrasonic vibration is also transmitted to the HFE layer L2 on the substrate W. As a result, the pure water can be reliably separated from the holes H on the substrate W.

### (3-4)

While the HFE layer L2 is formed by use of the straight type-rinsing process nozzle 70 in the first and second embodiments described above, the HFE layer L2 may be formed on the substrate W by use of a slit type-process nozzle as shown below.

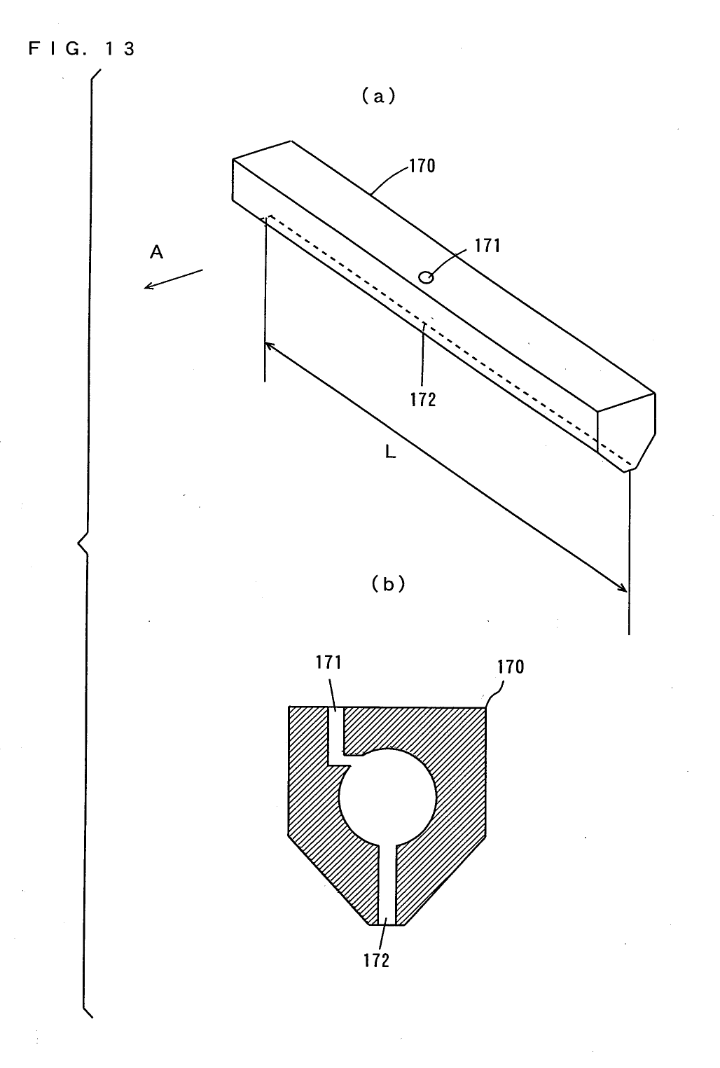

FIG. 13 (a) is an external perspective view showing the slit-type process nozzle, and FIG. 13 (b) is a schematic sectional view of the process nozzle shown in the FIG. 13 (a).

As shown in FIG. 13(a) and FIG. 13(b), the process nozzle 170 has an HFE supply port 171 and a slit-shaped discharge port 172. The width L of the slit-shaped discharge port 172 is set to be the same as or larger than the diameter of substrate W which is to be a processing target. The process nozzle 170 moves above the substrate W in a vertical direction to the slit-shaped discharge port 172 (see an arrow A).

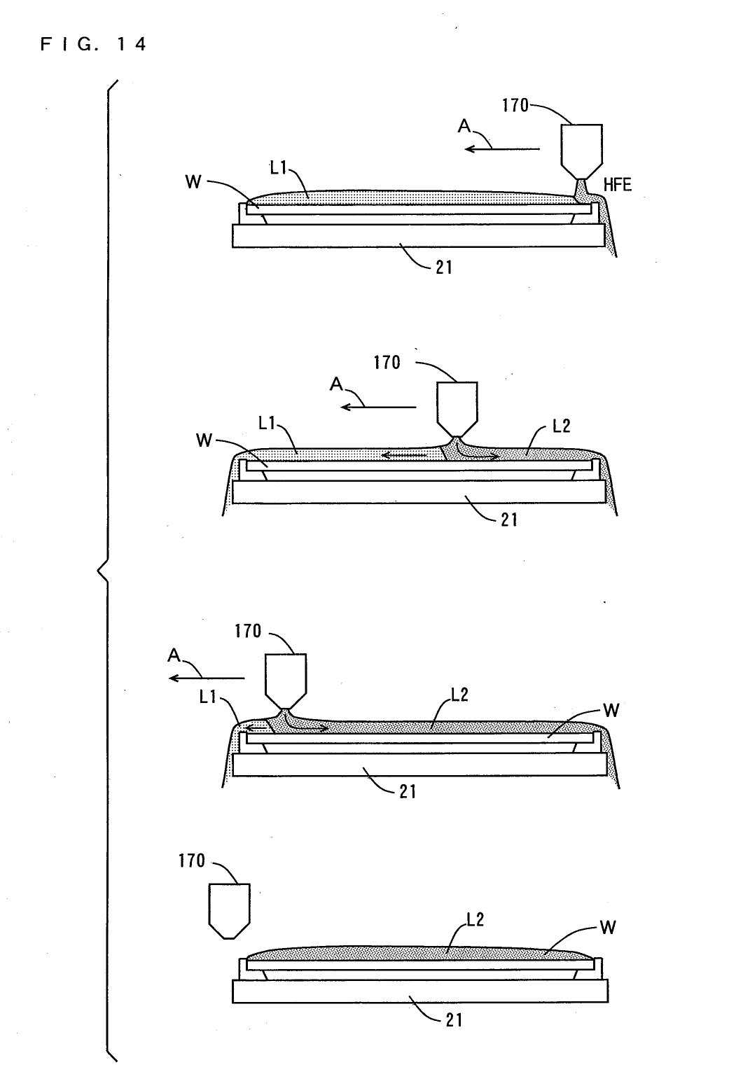

Next, an example in which the HFE layer L2 is formed by the process nozzle 170 will be described. FIG. 14 is a diagram for use in explaining the example in which the HFE layer L2 is formed by the process nozzle 170.

As mentioned above, a pure water layer L1 is formed on the substrate W after the rinsing process is performed on the substrate W (see FIG. 3(b) or FIG. 10(d)). Then, with the rotation of the substrate W stopped, the process nozzle 170 moves in the direction of the arrow A while discharging the HFE onto the substrate W as shown in FIG. 14 (a) to FIG. 14 (c).

Accordingly, the HFE is held on the substrate W from one end thereof to form the HFE layer L2 while the pure water layer L1 flows outwardly from the other end of the substrate W by a discharge pressure of the HFE applied by the process nozzle 170. The process nozzle 170 passes above the substrate W, so that the pure water layer L1 on the substrate W is replaced with the HFE layer L2, as shown in the FIG. 14(d).

In this way, the pure water layer L1 on the substrate W can be replaced with the HFE layer L2 without exposing the surface of the substrate W to the atmosphere also in the case where the slit type-process nozzle 170 is used.

Especially, in the substrate processing unit 5a to 5d according to the above second embodiment (see FIG. 7), the pure water layer L1 on the substrate W can be replaced with the HFE layer L2 efficiently and rapidly by using the process nozzle 170.

### (3-5)

While the HFE layer L2 on the substrate W is removed by rotating or inclining the substrate W in the above first and second embodiments, the HFE layer L2 on the substrate W may be removed by using the process nozzle 170 shown in FIG. 14.

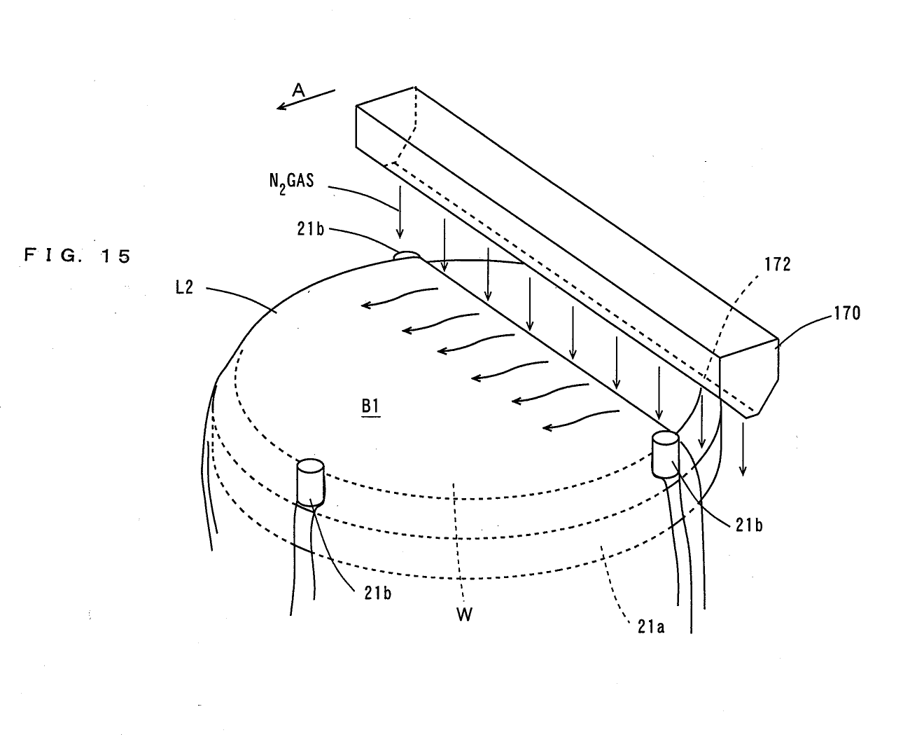

Specifically, as shown in FIG. 15, the process nozzle 170 moves in the direction of the arrow A while discharging the nitrogen gas toward the substrate W, so that the HFE layer L2 on the substrate W is pushed forward to a region B1 in a direction of travel of the process nozzle 170 to flow outwardly from the circumference of the substrate W in the region B1.

The process nozzle 170 passes above the substrate W, so that the HFE layer L2 is removed from the whole upper surface region of the substrate W. Note that in the substrate processing unit 5e to 5h shown in the above second embodiment (see FIG. 7), the process nozzle 170 may be moved from an upper end to a lower end of the substrate W to discharge the nitrogen gas in the state where the substrate W is inclined. In this case, the HFE layer L2 can be removed efficiently and reliably.

### (3-6)

A substrate rotation mechanism for rotating the substrate W may be additionally provided in the substrate processing unit 5a to 5d shown in the above second embodiment. In this case, when a chemical liquid layer L3, the pure water L1 and the HFE layer L2 are formed, the substrate is rotated at a speed such that these processing liquids will not be scattered outwardly from the substrate W, so that the chemical liquid layer L3, the pure water layer L1 and the HFE layer L2 are efficiently and evenly formed on the substrate W.

### (3-7)

While the nitrogen gas is used as an inert gas in the above first and second embodiments, other gas such as an argon gas or the like may be used instead of the nitrogen gas.

### (4) Correspondences between Structural Elements in Claims and Elements in the Embodiments

In the following paragraph, non-limiting examples of correspondences between various elements recited in the claims below and those described above with respect to various embodiments of the present invention are explained.

In the embodiments described above, the slit-shaped discharge port 172 is an example of a slit-shaped discharge port, the process nozzle 170 is an example of a nozzle having a slit-shaped discharge port. Furthermore, the spin chuck 21 is an example of a substrate holding device, and the rinsing process nozzle 70 is an example of a rinse liquid supplier or a holder, the process nozzle 170 is an example of the holder or an removing device, and the substrate inclining device 110 or the chuck rotation-driving mechanism 36 is an example of an removing device.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing method comprising the steps of:
supplying a rinse liquid on one surface of a substrate;
holding hydrofluoroether on said one surface of the substrate after the supply of the rinse liquid; and
removing the hydrofluoroether held on said one surface of the substrate.

2. The substrate processing method according to claim 1, wherein
said step of supplying the rinse liquid includes holding the rinse liquid on said one surface of the substrate, and
said step of holding the hydrofluoroether includes replacing the rinse liquid held on said one surface of the substrate with the hydrofluoroether without exposing said one surface of the substrate to outside air.

3. The substrate processing method according to claim 2, wherein
said step of holding the hydrofluoroether includes
rotating the substrate around an axis vertical to the substrate while holding the substrate approximately horizontally, and
discharging the hydrofluoroether toward the center of the substrate that is rotated.

4. The substrate processing method according to claim 2, wherein
said step of holding the hydrofluoroether includes
holding the substrate approximately horizontally, and
discharging the hydrofluoroether from a slit-shaped discharge port of a nozzle onto the substrate while moving the nozzle over said one surface of the substrate approximately in parallel to said one surface, the length of said discharge port being not smaller than a diameter of the substrate.

5. The substrate processing method according to claim 1, further comprising the step of applying an ultrasonic vibration to the hydrofluoroether held on said one surface of the substrate.

6. The substrate processing method according to claim 1, wherein said step of removing includes shaking off the hydrofluoroether held on said one surface of the substrate by rotating the substrate.

7. The substrate processing method according to claim 1, wherein said step of removing includes making the hydrofluoroether held on said one surface of the substrate flow downwardly by inclining the substrate.

8. The substrate processing method according to claim 1, wherein said step of removing includes supplying an inert gas on the substrate.

9. A substrate processing apparatus, comprising:
a substrate holding device that holds a substrate;
a rinse liquid supplier that supplies a rinse liquid on one surface of the substrate held by said substrate holding device;
a holder that holds hydrofluoroether on said one surface of the substrate held by said substrate holding device; and
a removing device that removes the hydrofluoroether held on said one surface of the substrate by said holder.
